(19) United States
(12) Patent Application Publication
(10) Pub. No.: US 2005/0096941 A1
(43) Pub. Date: May 5, 2005

(54) Method for saving medication costs by redistributing unused medications

(76) Inventor: Greg Tong, Palos Verdes Estates, CA (US)

Correspondence Address: STETINA BRUNDA GARRED & BRUCKER, 75 ENTERPRISE, SUITE 250, ALISO VIEJO, CA, 92656, US

(21) Appl. No.: 10/682,129

(22) Filed: Oct. 9, 2003

(51) Int. Cl. G06F 17/60

(52) U.S. Cl. 705/2

(57) ABSTRACT

There is provided a method of saving medication costs by redistributing unused medications. The method first features the step of receiving a request to fill a prescription for the medication of a patient serviced by a patient care facility. Thereafter, unit doses of the medication are assembled based upon the prescription. Each of the unit doses are individually identified with a lot number and an expiration date. The method further features the step of distributing the assembled unit doses to the patient care facility. Then, an unused portion of the unit doses is received from the patient care facility. An amount of such unused portion is identified and credited to the patient care facility. The identified unused portion of the unit doses are stored and later redistributed so as to mitigate the cost of the medication.

### CROSS-REFERENCE TO RELATED APPLICATIONS

(Not Applicable).

### STATEMENT RE: FEDERALLY SPONSORED RESEARCH/DEVELOPMENT

(Not Applicable).

### BACKGROUND OF THE INVENTION

The present invention relates generally to methods of saving medication and pharmacy labor costs, and more particularly to an improved method of returning unused medication to the pharmacy and labor costs from a patient care facility where applicable by law.

The most significant impact in pharmacy reimbursement procedures came when the Medicare program restructured its payment to patient care facilities from a “cost mark up” to a “per patient per day” rate. In other words, the Medicare program set up its payment protocol to disburse only a predetermined dollar amount to the patient care facilities. In reaction to this change, patient care facilities looked for ways of reducing their overall operating costs and overheads.

As part of this effort, patient care facilities began to purchase their pharmaceutical requirements from pharmacy providers that offer “per diem” pricing. In this respect, the rate for medications became constant regardless of the amount of drugs that a patient used. For example, the pharmaceutical prices were the same whether the patient used only one drug, five drugs or twelve drugs a day. Patient care facilities that were on fee for service pricing structure began requesting credit on unused medication.

Patient care facilities typically waste a significant number of drugs each month as a result of a change in the patient's condition, pharmaceutical requirement or discharge date. In order to prevent such wastes of medication that result from these kinds of situations, it would make sense to buy medications on a daily basis. However, doing so is cost prohibitive and impractical, and more detrimentally, could result in the patient running out of medication.

The standard practice for dispensing medications to patient care facilities is for the pharmacy to package them in what are often called “bingo cards” or “bubble cards” 10, as shown in FIG. 1. These cards 10 are typically fabricated from two pieces comprised of a cardboard backing and a thin plastic sheet of bubbles 12. Each bubble 12 is designed to store one dose of medication. Once the unit doses in the form of tablets or capsules are placed into the bubbles 12, the cards 10 can then be sealed with a layer of foil using a heat press.

Unused medications stored in the bingo or bubble cards 10 may be returned to the pharmacy providers provided that (1) they are put back into a bottle with the same lot number, and (2) the expiration dates on the repackaged medications are not more than one year from the date of their first use. By way of illustration, if a medication was dispensed on Sep. 1, 2003 and returned on Oct. 1, 2003, then the pharmacy provider cannot put on an expiration date of more than 11 months on the repackaged medication's prescription label.

However, medications which are packaged in bingo or bubble cards 10 typically have shorter expiration dates than the ones which are packaged individually in unit doses, that is, specifically measured quantities of medication each to be taken at one time. Moreover, medications stored in bingo or bubble cards 10 all share a same lot number and expiration date unlike the medications individually wrapped in unit doses which possess their own distinct lot number and expiration date.

Hence, upon their return, it is not always an easy task to restock medications from the bingo or bubble cards 10 into a bottle as all the medications in the bottle must have the same lot number in accordance with the current pharmaceutical regulations. In addition to this requirement, the shorter expiration dates of such medications tend to cut down or limit the duration in which the restocked or repackaged medications may be reused. Notwithstanding the foregoing, the physical labor of punching out the unused doses from each bubble 12 and restocking them in a bottle may become arduous and time-consuming, especially when such procedure is performed repetitively throughout the day.

Thus, there has long been a need in the pharmaceutical and patient care industries in particular, for a method of saving overall medication costs by redistributing and/or reutilizing unused medications which are returned from health care facilities. In particular, there is a need to redistribute and/or reutilize these unused medications without being subjected to shortened expiration dates, strict bottling or restocking requirements as compelled by the current pharmaceutical regulations, and significant pharmacy labor requirements.

### BRIEF SUMMARY OF THE INVENTION

In accordance with the present invention, there is provided a method of saving medication costs through crediting patient care facilities for any unused medications or reuse by the pharmacy if the patient's billing status is a per diem rate The unused medications may later be reused or redistributed. In particular, the method first features the step of receiving a request to fill a prescription for the medication of a patient serviced by a patient care facility.

The method further features the step of assembling unit doses of the medication based upon the prescription. Each of the unit doses are individually identified with a lot number and an expiration date. In particular, each of the unit doses are packaged individually. The lot numbers and the expiration dates are indicated on each of the respective packaged unit doses. The indicated lot numbers and the expiration dates on each of the individually packaged unit doses may be different from each other.

The method also includes the step of distributing the assembled unit doses to the patient care facility. More particularly, a unit dose card with a medication receptacle is obtained. The medication receptacle may be formed separately with the unit dose card. In this embodiment, the medication receptacle may be a bag which is attached to the unit dose card. Alternatively, however, the medication receptacle may be formed unitarily with the unit dose card. In this alternative embodiment, the unit dose card may be an envelope and the medication receptacle may be a pouch of the envelope.

The unit doses are then inserted into the medication receptacle of the unit dose card. Thereafter, the medication receptacle of the unit dose card is enclosed for distribution to the patient care facility. Patient information may be indicated on the unit dose card. Additionally, prescription information may also be indicated on the unit dose card.

Further in the present invention, the method comprises the step of receiving an unused portion of the unit doses from the patient care facility. The method then involves identifying an amount of the unused portion of the unit doses. The unit dose card, which was provided with the distributed unit doses, is completed so as to record the identified unused portion of the unit doses. Specifically, the unit dose card is separated from the unit doses. The amount of the unused portion of the unit doses is recorded on the top and bottom card halves of the unit dose card.

The method of the present invention additionally comprises the step of crediting where applicable the patient care facility for the identified unused portion of the unit doses. The patient care facility may be reimbursed for the identified unused portion of the unit doses. This may involve separating the unit dose card wherein a selected portion defined about the top half of the card may be retained. The remaining portion of the unit dose card may be sent off to the patient care facility. Optionally, the unit dose card may be selectively perforated about the top half of the card to facilitate the separation of the selected portion from the remaining portion of the unit dose card.

Moreover, the method comprises the step of storing the unused portion of the unit doses. The unused portion returned to the pharmacy provider is preferably stored in bins with other unit doses of the same manufacturer, drug, strength and/or dosage form. Select ones of the unit doses may be removed from storage. Select ones of the unit doses may also be removed from storage based upon the expiration dates. Lastly, the method of the present invention features the step of redistributing the unit doses within an indicated expiration date.

### BRIEF DESCRIPTION OF THE DRAWINGS

These as well as other features of the present invention will become more apparent upon reference to the drawings wherein:

FIG. 1 is a front view of a prior art bingo card and illustrating its storage bubbles each for storing a dose of medication therein;

FIG. 2 is a block diagram symbolizing a preferred method of the present invention and illustrating the manner in which medications are exchanged between a pharmacy provider and a patient care facility;

FIG. 3 is front view of a unit dose card constructed in accordance with a first preferred embodiment of the present invention and illustrating its direct attachment to the medications via a fastener for identifying amounts of unused medications that are returned by the patient care facility shown in FIG. 2;

FIG. 4 is a rear view of the unit dose card shown in FIG. 3 and illustrating two credit information portions which are separable from each other via perforated lines;

FIG. 4 is a front view of a unit dose card constructed in accordance with a second preferred embodiment of the present invention and illustrating its attachment to the medications via a string;

FIG. 5 is a front view of a unit dose card constructed in accordance with a second preferred embodiment of the present invention which is utilized for identifying amounts of unused medications that are returned by the patient care facility shown in FIG. 2;

FIG. 6 is a front view of medications that are delivered to and returned from the patient care facility shown in FIG. 2 and illustrating the manner in which they are individually packaged in unit doses with distinct lot numbers and expiration dates; and

FIG. 7 is a flow diagram of a process for saving medication costs through crediting the patient care facility shown in FIG. 2 for any unused medications which are returned.

### DETAILED DESCRIPTION OF THE INVENTION

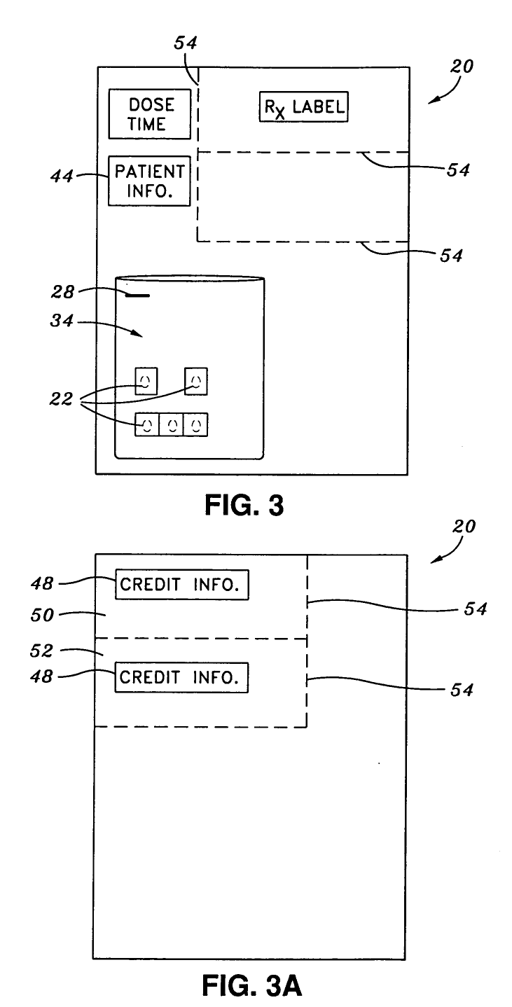

Referring now to the drawings wherein the showings are for purposes of illustrating preferred embodiments of the present invention only, and not for purposes of limiting the same, FIG. 3 frontally illustrates a unit dose card 20 constructed in accordance with a preferred embodiment of the present invention. The unit dose card 20 is adapted to accompany a plurality of individually packaged unit doses 22 of medication when they are delivered to a patient care facility 24 and the unused portion thereof are returned to a pharmacy provider 26. As will be demonstrated below, the pharmacy provider 26 utilizes the unit dose card 20 to identify the unit doses 22 which were not used so as to credit the patient care facility 24 accordingly.

Before proceeding with the substantive explanations of the present invention, it is important to clarify certain terminologies used herein for the purpose of better understanding the present invention. First, the term “patient care facility” 24 used throughout this section should not be construed narrowly, but rather broadly to mean any type of facility that provides health care. Examples of such facilities include, but are not limited to, assisted living homes, hospitals, hospices, retirement homes, and the like. Furthermore, the term “pharmacy provider” 26 should also be interpreted broadly to include any person or entity that provides pharmaceuticals or medications to the patient care facility 24 such as pharmacists, pharmaceutical companies, pharmaceutical wholesalers or salespeople, etc. Lastly, the term “unit dose” 22 should be defined as any type of medication which is individually packaged and precisely quantified to be taken at one time.

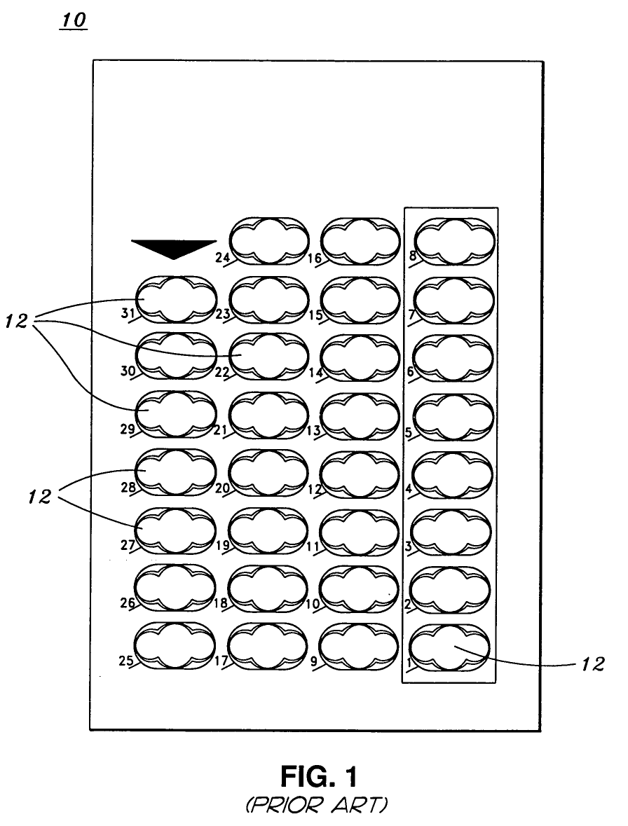

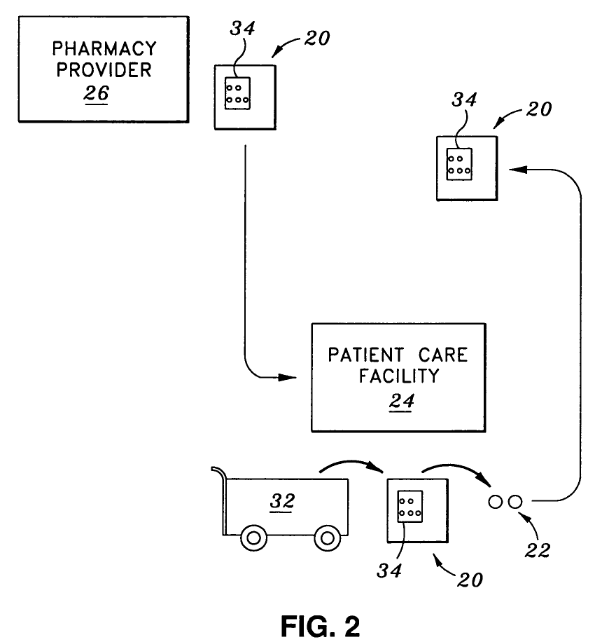

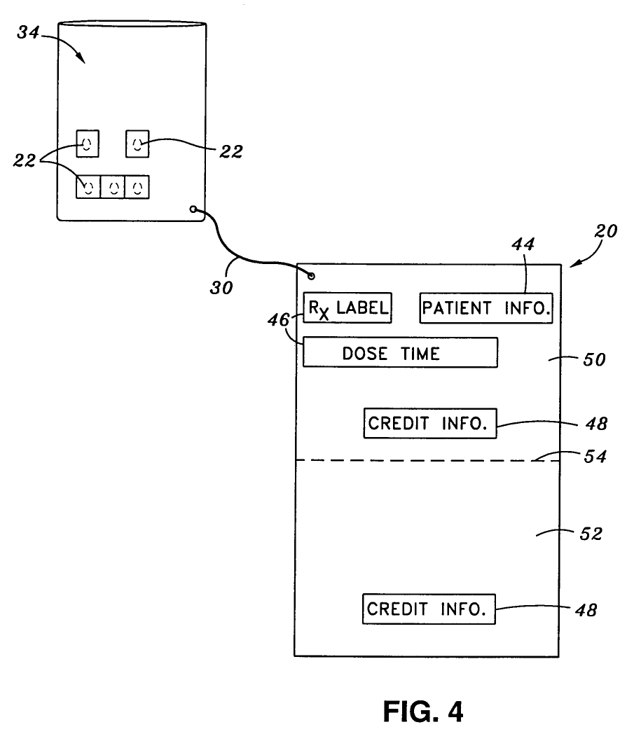

With the essential terminologies now defined, the substantive details of the present invention can now be optimally described. Referring more particularly to FIGS. 2, 3 and 4, the unit dose card 20 may be formed to have a variety of shapes, sizes, configurations and geometries, and may be fabricated from various materials. As the unit dose card 20 may be any general desired shape, it is understood that the unit dose card 20 as depicted is symbolic in nature. However, it is preferred that the unit dose card 20 used in the present invention simulates the general shape and size of the prior art bingo card 10 (shown in FIG. 1). This allows the unit dose card 20 to easily adjust to and be stored in conventional medication carts 32 which are currently used in patient care facilities 24.

The unit dose card 20 may be attached to the unit doses 22 of medication via a fastener 28 such as staples, safety pin, paper clip and the like, or via a string 30. More specifically, the unit dose card 20 is attached to a medication receptacle 34 containing the individually packaged unit doses 22. Preferably, the medication receptacle 34 is a bag which can accommodate and enclose the unit doses 22 therein, and more preferably a plastic bag. However, it should be recognized herein that the bag may be fabricated from other types of material such as paper. As a further example, the medication receptacle 34 may take the form of an envelope stapled to the unit dose card 20.

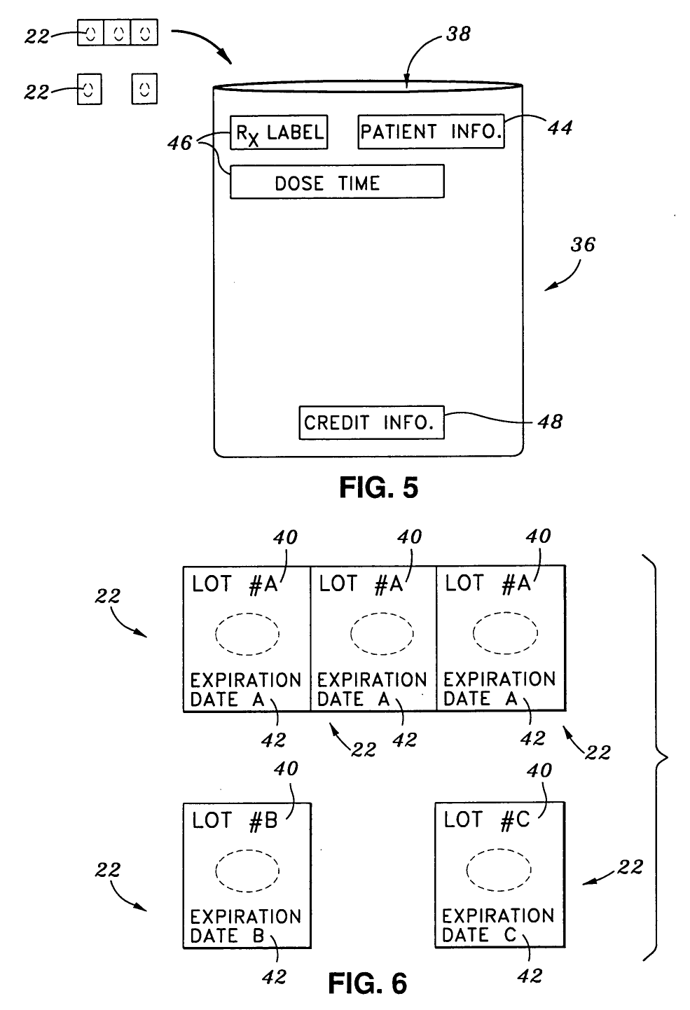

FIG. 5 illustrates an alternative construction of the unit dose card 36. In this alternately preferred embodiment, the unit dose card 36 and the medication receptacle 34 are unitarily formed so as to eliminate the need for any type of attachment between the two. In particular, the medication receptacle 34 is provided with the unit dose card 36 for accommodation of the unit doses 22. In order to produce the unit dose card 36 of such descriptions, the unit dose card 36 in this embodiment is an envelope of various sizes, rather than a separate card, which provides an enclosable pouch 38 therewithin for the individually wrapped and sealed unit doses 22 of medication.

Regardless of which version of the unit dose card 20 or 36 is used between the pharmacy provider 26 and the patient care facility 24, the units doses 22 of medication are first inserted into and then enclosed within the medication receptacle 34. Any number of unit doses 22 may be provided within the medication receptacle 34 depending upon the specific need of each patient (e.g., fourteen day supply). Simply put, the number and type of medication provided should conform to the patient care facility's request to fill a prescription for a patient serviced thereby. As indicated above, the unit doses 22 are individually packaged so that each unit dose 22 can be separately opened in its respective dose time for medication. In this regard, the packaged unit doses 22 may be obtained directly from the drug manufacturer or drug wholesaler. Thus, this allows the unit doses 22 to have longer expiration dates than the medications packaged at the pharmacy level in traditional bingo cards 10 such as shown in FIG. 1.

Importantly, however, lot numbers 40 and expiration dates 42 are labeled on each of the packaging of the unit doses 22. The lot numbers 40 and expiration dates 42 on each of the packaging are unique to their own respective unit doses 22 of medication, and therefore may vary from that of the others contained in the medication receptacle 34. Due to such lot numbers 40 and expiration dates 42 being unique to their respective packaged unit doses 22, the unit doses 22 of medication may more easily be put back into the pharmacy provider's inventory as they are not subjected to regulatory difficulties associated with restocking the medication back into stock bottles.

Referring now to FIGS. 3-5, patient information 44 may be provided on the unit dose card 20 so as to identify the specific patient that the unit doses 22 of medication are intended for. Such information may include, but are not limited to, patient's name, residential address, age, sex, telephone number(s), emergency contact and the like. The patient information 44 may be placed on any location of the unit dose card 20 such as near the upper right hand corner thereof. Further, prescription information 46 may additionally be provided on the unit dose card 20. Likewise, the prescription information 46 may be placed on any location of the unit dose card 20 such as near the upper left hand corner of the card 20. These information may include, but are not limited to, prescription label, dose times, prescription ingredients, prescription directions and the like. The patient and prescription information 44, 46 may be hand written or typed on the card 20, or labeled on a sticker and stuck on the card 20.

As illustrated in FIG. 2, the unit dose card 20 and the individually packaged unit doses 22 of medication are delivered to the patient care facility 24 for use. Preferably, the personnel or staffs (e.g., nurses, doctors, assistants, etc.) at the patient care facility 24 have already been educated on where to store the unit dose card 20 in the medication cart 32, how the card 20 is intended to be used and how to return the unused portions of unit doses 22 of medication. Similar to the conventional practice utilizing bingo or punch cards 10, the unit doses 22 of medication for a particular patient is preferably stored and maintained in the medication cart 32 by the room number of the patient. In the event that all the unit doses 22 of medication are used up by the patient, then the unit dose card 20 corresponding to those unit doses 22 may be discarded or kept as record.

However, if any unit doses 22 of medication are left over due to patient's early discharge, change in prescription or death, for example, then the unused portion of the unit doses 22 can be returned back to the pharmacy provider 26. This allows the patient care facility 24 to be credited for such unused portion, and hence mitigate its overall medication costs. In order to return the unused portion of the unit doses 22, one of the personnel or staff at the patient care facility 24 first completes a medication disposition form (not shown) and a drug return form (not shown). The completed drug return form is then sent to the pharmacy provider 26, such as via facsimile, where a pickup slip (not shown) is issued. It is contemplated that the drug return form may be completed on-line and sent over a computer network for another example. Upon issuance of the pickup slip, the drug return form, along with the unused unit doses 22 of medication and their corresponding unit dose card 20, are sent over to the pharmacy provider 26 (via a driver, for example).

Upon receipt by the pharmacy provider 26, the pharmacy provider 26 may sign the drug return form to indicate receipt or otherwise acknowledge receipt of the unused unit doses 22. The pharmacy provider 26 may then send the original drug return form back to the patient care facility 24 and retains a copy of the form for himself or herself. The pharmacy provider 24 completes the credit information 48 indicative of the amount of the unused unit doses 22 on the returned unit dose card 20. It should be noted herein that such credit information 48 may be recorded anywhere on the unit dose card 20, whether it be its front side or backside. However, it is preferred that the credit information 48 is provided on both the provider's portion 50 and the facility's portion 52 of the unit dose card 20 for the reasons stated below.

Referring now to FIGS. 2-4, the provider's and facility's portions 50, 52 of the unit dose card 20 is then separated apart from each other. One of the card portions 50 or 52 (e.g., facility's portion 52) is sent to the patient care facility 24. The remaining card portion 50 or 52 (e.g., provider's portion 50) of the unit dose card 20 is kept by the pharmacy provider 26 as a record of unused unit doses 22 which were returned by the patient care facility 24. Although not required, the unit dose card 20 may optionally include a number of perforation lines 54 to facilitate the separation between the two portions 50, 52 of the card 20.

Thereafter, the pharmacy provider 26 is then ready to credit the patient care facility 24 for the identified unused portion of the unit doses 22. It should be specifically stated herein that any known procedure of crediting the patient care facility 24 may be practiced as long as the primary objective of ultimately saving the overall medication costs is achieved. For instance, the patient care facility 24 may simply be reimbursed for the unused unit doses 22 of medication. In the alternative, a cost deduction may be made from the next billing to the patient care facility 24, or from the next medication purchase thereby. Additionally, it is contemplated herein that the patient care facility 24 may optionally receive the credit on behalf of its patients. Simply put, there are various ways in which the patient care facility 24 may be credited.

The unused unit doses 22 of medication that are returned from the patient care facility 24 are then stored for later redistribution and/or reuse by the pharmacy provider 26. Although they may be stored in any fashion, it is preferred that the unused unit doses 22 are returned to their corresponding medication bin or bins (not shown). Periodically, some of the stored unit doses 22 may be removed from storage based upon their lot numbers 40 and/or expiration dates 42. For example, the pharmacy provider 26 may audit the stored unit doses 22 of medication due to expire in six months or less during inventory performed each quarter. The expired medication may be disposed of by the pharmacy provider's contracted waste management vendor. The unit doses 22 of medication which survive the auditing or removal may be redistributed or reused at a later time by the pharmacy provider 26.

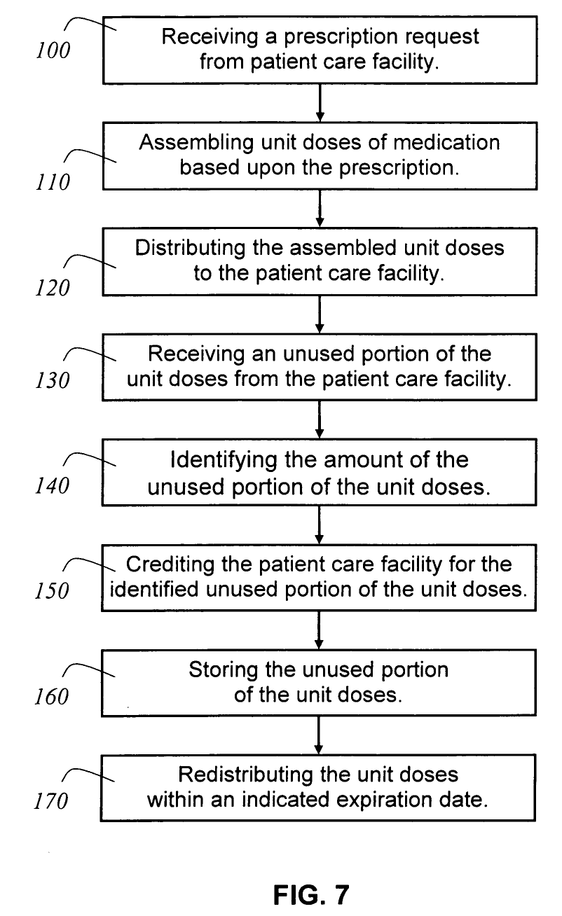

Referring now to FIG. 7, there is depicted a flow diagram of aspects of the present invention.

According to an aspect of the present invention, there is provided a method of redistributing a medication. The method begins with the initial step 100 of receiving a request to fill a prescription for the medication of a patient serviced by a patient care facility 24. The method further comprises step 110 of assembling unit doses 22 of the medication based upon the prescription, each of the unit doses 22 being individually identified with a lot number 40 and an expiration date 42. The method additionally comprises step 120 of distributing the assembled unit doses 22 to the patient care facility 24. The method continues with step 130 of receiving an unused portion of the unit doses 22 from the patient care facility 24 and step 160 of storing the unit doses 22. Lastly, the method comprises step 170 of redistributing the unit doses 22 within an indicated expiration date 42.

Step 110 may include packaging each of the unit doses 22 individually and indicating the lot numbers 40 and the expiration dates 42 on each of the respective packaged unit doses 22. Step 120 may include obtaining a unit dose card 20 with a medication receptacle 34, inserting the unit doses 22 into the medication receptacle 34 of the unit dose card 20, and enclosing the medication receptacle 34 of the unit dose card 20 for distribution to the patient care facility 24′. Step 120 may further include indicating patient information 44 on the unit dose card 20 and indicating prescription information 46 on the unit dose card 20. Step 130 may further include identifying an amount of the unused portion of the unit doses 22, completing a unit dose card 20 provided with the distributed unit doses 22 to record the identified unused portion of the unit doses 22, and crediting the patient care facility 24 for the identified unused portion of the unit doses 22. Step 160 may further include removing select ones of the unit doses 22 from storage based upon the lot numbers 40 and/or removing select ones of the unit doses 22 from storage based upon the expiration dates 42.

According to another aspect of the present invention, there is provided a method of mitigating a medication cost for a medication. The method involves steps 100-130 and continues with step 140 of identifying an amount of the unused portion of the unit doses 22. The method further comprises step 150 of crediting the patient care facility 24 for the identified unused portion of the unit doses 22 to mitigate the medication cost of the medication.

Step 140 may include separating a unit dose card 20 with top and bottom halves 50, 52 from the unit doses 22 and recording the amount of the unused portion of the unit doses 22 on the top and bottom card halves 50, 52 of the unit dose card 20. Step 140 may further include separating the top and bottom card halves 50, 52 of the unit dose card 20, retaining one of the card halves 50 or 52, and sending the remaining one of the card halves 50 or 52 of the unit dose card 20 to the patient care facility 24. Step 150 may include reimbursing the patient care facility 24 for the identified unused portion of the unit doses 22.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A method of redistributing a medication, the method comprising the steps of:
a) receiving a request to fill a prescription for the medication of a patient serviced by a patient care facility;
b) assembling unit doses of the medication based upon the prescription, each of the unit doses being individually identified with a lot number and an expiration date;
c) distributing the assembled unit doses to the patient care facility;
d) receiving an unused portion of the unit doses from the patient care facility;
e) storing the unit doses; and
f) redistributing the unit doses within an indicated expiration date.

2. The method of claim 1 wherein step b) comprises:
1) packaging each of the unit doses individually; and
2) indicating the lot numbers and the expiration dates on each of the respective packaged unit doses.

3. The method of claim 2 wherein the indicated lot numbers and the expiration dates on each of the individually packaged unit doses are different from each other.

4. The method of claim 1 wherein step c) comprises:
1) obtaining a unit dose card with a medication receptacle;
2) inserting the unit doses into the medication receptacle of the unit dose card; and
3) enclosing the medication receptacle of the unit dose card for distribution to the patient care facility.

5. The method of claim 4 wherein the medication receptacle is formed separately with the unit dose card.

6. The method of claim 5 wherein the medication receptacle is a bag attached to the unit dose card.

7. The method of claim 4 wherein the medication receptacle is formed unitarily with the unit dose card.

8. The method of claim 7 wherein the unit dose card is an envelope and the medication receptacle is a pouch of the envelope.

9. The method of claim 4 wherein step 3) further comprises:
i) indicating patient information on the unit dose card; and
ii) indicating prescription information on the unit dose card.

10. The method of claim 1 wherein step d) further comprises:
1) identifying an amount of the unused portion of the unit doses;
2) completing a unit dose card provided with the distributed unit doses to record the identified unused portion of the unit doses; and
3) crediting the patient care facility for the identified unused portion of the unit doses.

11. The method of claim 1 wherein step e) further comprises removing select ones of the unit doses from storage based upon the lot numbers.

12. The method of claim 1 wherein step e) further comprises removing select ones of the unit doses from storage based upon the expiration dates.

13. A method of mitigating a medication cost for a medication, the method comprising the steps of:
a) receiving a request to fill a prescription for the medication of a patient serviced by a patient care facility;
b) assembling unit doses of the medication based upon the prescription, each of the unit doses being individually identified with a lot number and an expiration date;
c) distributing the assembled unit doses to the patient care facility;
d) receiving an unused portion of the unit doses from the patient care facility;
e) identifying an amount of the unused portion of the unit doses; and
f) crediting the patient care facility for the identified unused portion of the unit doses to mitigate the medication cost of the medication.

14. The method of claim 13 wherein step b) comprises:
1) packaging each of the unit doses individually; and
2) indicating the lot numbers and the expiration dates on each of the respective packaged unit doses.

15. The method of claim 14 wherein the indicated lot numbers and the expiration dates on each of the individually packaged unit doses are different from each other.

16. The method of claim 13 wherein step c) comprises:
1) obtaining a unit dose card with a medication receptacle;
2) inserting the unit doses into the medication receptacle of the unit dose card; and
3) enclosing the medication receptacle of the unit dose card for distribution to the patient care facility.

17. The method of claim 16 wherein the medication receptacle is formed separately with the unit dose card.

18. The method of claim 17 wherein the medication receptacle is a bag attached to the unit dose card.

19. The method of claim 16 wherein the medication receptacle is formed unitarily with the unit dose card.

20. The method of claim 19 wherein the unit dose card is an envelope and the medication receptacle is a pouch of the envelope.

21. The method of claim 16 wherein step 3) further comprises:
i) indicating patient information on the unit dose card; and
ii) indicating prescription information on the unit dose card.

22. The method of claim 13 wherein step d) further comprises:
1) storing the unused portion of the unit doses; and
2) removing select ones of the unit doses from storage based upon the lot numbers.

23. The method of claim 13 wherein step d) further comprises:
1) storing the unused portions of the unit doses; and
2) removing select ones of the unit doses based upon the expiration dates.

24. The method of claim 13 wherein step e) comprises:
1) separating a unit dose card with provider's and facility's card portions from the unit doses; and
2) recording the amount of the unused portion of the unit doses on the provider's and facility's card portions of the unit dose card.

25. The method of claim 24 wherein step 2) further comprises:
i) separating the provider's and facility's card portions of the unit dose card;
ii) retaining the provider's card portion of the unit dose card; and
iii) sending the facility's card portion of the unit dose card to the patient care facility.

26. The method of claim 25 wherein the unit dose card is perforated between the provider's and facility's card portions.

27. The method of claim 13 wherein step f) comprises reimbursing the patient care facility for the identified unused portion of the unit doses.

28. The method of claim 13 further comprising:
g) redistributing the unit doses within an indicated expiration date.
